(19) United States
(12) Patent Application Publication
(10) Pub. No.: US 2026/0103595 A1
(43) Pub. Date: Apr. 16, 2026

(54) Polyamide 56 Blended Composition With Reduced Moisture Absorption

(71) Applicant: TE Connectivity Solutions GmbH, Schaffhausen (CH)

(72) Inventors: Dejie TAO, Fremont, CA (US); Lei WANG, San Jose, CA (US); Megan Hoarfrost BEERS, Redwood City, CA (US); Ting GAO, Palo Alto, CA (US)

(73) Assignee: TE Connectivity Solutions GmbH, Schaffhausen (CH)

(21) Appl. No.: 18/912,665

(22) Filed: Oct. 11, 2024

(51) Int. Cl. C08L 77/06

(52) U.S. Cl. CPC C08L 77/06; C08L 2205/025

(57) ABSTRACT

A polyamide 56 blended composition comprises a polyamide 56 polymer and a low moisture absorption polyphthalamide. The polyamide 56 blended composition can also be made from a polyamide 56 copolymer and a low moisture absorption polyphthalamide. The polyamide 56 blended composition can be molded into various articles.

### FIELD OF THE INVENTION

The present invention relates to a polyamide 56 blended composition with reduced moisture absorption.

### BACKGROUND OF THE INVENTION

Polyamides, also known as nylons, are some of the most widely used thermoplastic materials due to their physical characteristics. Polyamides are polymers with repeat units linked by amide bonds, produced, for example, by the condensation of a diacid and diamine. They have good abrasion and wear resistance, as well as high chemical and corrosion resistance. Polyamides have flexibility and low density in addition to ultraviolet resistance. Traditional polyamides are generally easily moldable. In light of these characteristics, polyamides play an important role in many automotive, electrical, and consumer goods applications.

As many traditional polyamides are made from fossil fuels which emit carbon dioxide and contribute to global warming, there has been an increased attempt to use biobased polyamides. Examples of biobased polyamides include but are not limited to polyamide 56 and polyamide 1010. Notwithstanding the beneficial properties of biobased polyamides, many of these biobased polyamides have higher moisture absorption than traditional polyamides. For example, polyamide 56 has many similar properties to polyamide 66, but has higher moisture absorption. Moisture absorption may cause loss in tensile strength and modulus due to the interaction of moisture with the polyamide polymer chain. A product made from biobased polyamide may also have a loss of electrical performance and dimensional stability due to moisture absorption.

Polymers are blended together to achieve properties and performance that each of the underlying individual polymers may not have. Blending polymers provides a cost effective strategy for creating new types of materials. Generally, polymers which are blended together should be compatible with each other in order to achieve new properties.

Shouyun Zhang describes a blend of bio-based polyamide 56 and polyethylene terephthalate polymers in an article published in e-Polymers. Zhang, Shouyun. (2023). e-Polymers 2023:23:20228082. Based upon experimental results, Zhang concluded that the blend of polyamide 56 and polyethylene terephthalate had poor performance properties due to the lack of compatibility between the two polymers.

Chinese Patent No. CN111825975B, published on Sep. 12, 2022, assigned to Kasai Shanghai Biotechnology Co. Ltd, describes a polyamide composition and a method of preparation of such composition. The polyamide composition comprises 100 parts of polyamide 56, 10-30 parts of a long chain polyamide and 5-50 parts of an auxiliary agent. The long carbon chain polyamide is a polyamide with the number of methylene groups between adjacent amide groups on the main chain greater than or equal 10. The auxiliary agent includes at least a mineral filler selected from the group of talc, calcium carbonate, barium sulfate, mica powder and kaolin.

Chinese Patent No. CN115260756B, published on Jun. 11, 2024, assigned to Suzhou Sunway Polymer Co., describes a halogen-free flame retardant, bio-based high temperature-resistant nylon alloy/polyphenyl ether composite material. The material described in the patent is a mixture of polyamide 56, polyamide 10T, polyphenylene ether, flame retardant, toughening agent, nucleating agent, antioxidant and lubricant. The patent states that the composite material of the patent achieved excellent heat resistance, low moisture absorption, excellent alcohol resistance and excellent flame retardancy.

He et. al. describe the improvement of the anti-moisture absorption and thermal properties of bio-based polyamides. He, Lulu & An, Taofang & He, Min & Fan, Qiao & Yang, Jifei & Liu, Yufei & Qin, Shuhao & Yu, Jie. (2023) Journal of Applied Polymer Science, 140. 10.1002/app.54301. Anti-moisture absorption and high thermal properties were achieved in bio-based polyamide 56/F-based heat-resistant agent composites through crystal regulation. The improved properties were obtained by the addition of two heat resistant agents. The two heat resistant agents that were used were p(N-(4-F-phenylmaleimide)-alt-styrene) (PFS) and p(N-(4-F-phenylmaleimide)-alt-triallyl isocyanurate) (PFT). The composite of polyamide 56 and PFS had increased anti-moisture absorption by 14.6% over polyamide 56 by itself. The composite of polyamide and PFT had increased anti-moisture absorption by 15.5% over polyamide 56 by itself. The authors noted that these composites can be used in the automotive industry.

Nonetheless, there exists a need for a polyamide 56 blended composition with reduced moisture absorption.

### SUMMARY OF THE INVENTION

An embodiment is directed to a polyamide 56 blended composition comprising a polyamide 56 and a low moisture absorption polyphthalamide.

Another embodiment is directed to an article made from a polyamide 56 blended composition comprising a polyamide 56 and a low moisture absorption polyphthalamide.

Yet another embodiment is directed to a polyamide 56 blended composition comprising a polyamide 56 copolymer and a low moisture absorption polyphthalamide.

Still yet another embodiment is directed to an article made from a polyamide 56 blended composition comprising a polyamide 56 copolymer and a low moisture absorption polyphthalamide.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

The accompanying drawings, which are incorporated into and form a part of the specification, schematically illustrate one or more illustrative embodiments of the invention and, together with the general description given above and detailed description given below, serve to explain the principles of the invention, and wherein:

FIG. 1 is a chart showing the water absorption results of polyamide 56 blended with a low moisture absorption polyphthalamide at different concentrations.

FIG. 2 is a chart showing the water absorption results of a polyamide 56 copolymer blended with a low moisture absorption polyphthalamide at various concentrations compared to polyamide 56 and conventional polyamide 66.

### DETAILED DESCRIPTION OF THE INVENTION

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise.

Moreover, the features and benefits of the invention are illustrated by reference to the preferred embodiments. Accordingly, the invention expressly should not be limited to such embodiments illustrating some possible non-limiting combination of features that may exist alone or in other combinations of features, the scope of the invention being defined by the claims appended hereto.

The polyamide 56 blended composition of the instant invention comprises biobased polyamide resins and biobased polyamide copolymer resins. Biobased polyamide resins can be produced using polycondensation processes with diamines and dioic acids of different chain lengths. Polyamide 56 resin is polymerized from biobased 1,5 diaminopentane and fossil based adipic acid. In addition, the polyamide 56 resin can be further modified with comonomers to form polyamide 56 copolymer resins. Examples of a commercially available polyamide 56 resins that can be used in the instant invention include ECOBLEND N56F from Shanghai Kumho Sunny Plastics Co., Ltd., BIONYLA C100-NC002 from Kingfa Sci.& Tech. Co., Ltd. and BIONYLA R30G0001 from Kingfa Sci.& Tech. Co., Ltd. An example polyamide 56 copolymer resin that can be used in the instant invention is ECOPENT 6631 from Cathay Biotech, Inc.

The polyamide 56 blended composition also includes a low moisture absorption polyphthalamide in addition to the polyamide 56. A low moisture absorption polyphthalamide has a saturated water absorption less than 5 weight percent when immersed in water according to the ISO 62 water absorption test. A polyphthalamide is a polyamide in which residues of terephthalic acid or isophthalic acid or a combination of the two comprise at least 55 molar percentage of the dicarboxylic acid portion of the repeating structural units in the polymer chain (ASTM D5336). The low moisture absorption polyphthalamide which can be used in the polyamide 56 blended composition can be, and is defined as, any polyphthalamide that has less water absorption than a polyamide 56 by itself, when both are tested using the same test conditions. Preferably, the low moisture absorption polyphthalamide is a poly-condensation product of monomers comprised of at least aliphatic diamine and at least one aromatic dicarboxylic acid. The low moisture absorption polyphthalamide can also be made with other co-monomers, which serve purposes such as lowering the processing temperature.

Examples of a low moisture absorption polyphthalamide that can be used in the polyamide 56 blended compositions, include but are not limited to polyamide 6T, polyamide 9T, polyamide 10T and polyamide 10T copolymers such as PA10TX, all of which are made from monomers of terephthalic acid containing terephthalamide.

Polyamide 10T, which is poly(decamethylene terephthalamide), has a structure as set forth below:

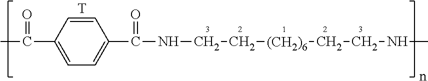

An example of a commercially available polyamide 10T is VICNYL R6100 from Kingfa Sci.& Tech. Co., Ltd. An example of a commercially available polyamide 10TX is VICYNL 2700 EB from Kingfa Sci.& Tech. Co., Ltd.

Preferably, polyamide 10TX is used as the low moisture absorption polyphthalamide in a blended polyamide 56 composition. Polyamide 10TX has similar processing temperatures to polyamide 56 resins which enables easier molding as compared to a blended polyamide 56 composition which uses polyamide 10T.

The low moisture absorption polyphthalamide comprises about 20 wt. % or less of the polyamide 56 blended composition. Preferably, the low moisture absorption polyphthalamide is in the range of about 3 to about 10 wt. % of the polyamide 56 blended composition and more preferably, in the range of about 5 to about 10 wt. % of the polyamide 56 blended composition.

Other conventional additives may be added to the polyamide 56 blended composition. Examples of conventional additives include pigments, dyes, voiding agents, antistatic agents, foaming agents, plasticizers, radical scavengers, anti-blocking agents, anti-dust agents, antifouling agents, surface active agents, slip aids, optical brighteners, viscosity modifiers, gloss improvers, dispersion stabilizers, UV stabilizers, UV absorbers, antioxidants such as phenol antioxidants or amine antioxidants, lubricity agents, process aids, heat stabilizers, hydrolysis stabilizers, cross-linking activators, coupling agents, radio opacifiers (such as for example, but not limited to, barium sulfate), tungsten metal, non-oxide bismuth salts, colorants, reinforcing agents, impact strength modifiers, compatibilizing agents, flame retardants, and any combination thereof. Such additives may be included in conventional amounts.

The polyamide 56 resin can be mixed with the low moisture absorption polyphthalamide to form a polyamide 56 blended composition. The mixing equipment can be any suitable equipment used in the art of mixing concentrated solids. Examples of such suitable equipment include a batch mixer, such as a Brabender mixer and a Banbury mixer, a single extruder, a twin screw extruder, high speed centrifugal mixers and the like.

The polyamide 56 blended composition can be molded into various articles according to a molding method generally employed for a thermoplastic resin composition, including but not limited to injection molding, injection compression molding, extrusion molding, press forming, blow molding, calender molding or cast molding. In particular, from the viewpoint of ease in molding, mass productivity and cost, injection molding is the preferred molding method.

The polyamide 56 blended composition can be molded into many different parts. For example, the composition can be made into seals, gaskets, connectors, housings, wires, cables, printed wire boards, or EMI shields as well as other electronic or computer components. The composition can be used to make electronic components, such smart phones, general automotive parts, electric motors, e-powertrains, batteries and battery enclosures, chargers for electric vehicles and other components of electric vehicles. In addition, the composition of the instant invention can be used to make molded parts. Furthermore, the polyamide 56 blended composition of the instant invention can also be used to make medical devices, surgical instruments, medical enclosures or wearable medical devices. Moreover, the polyamide 56 blended composition of the instant invention can be used to manufacture any product which withstands load or has mechanical function.

### EXAMPLES

Various samples of a polyamide 56 blended composition were prepared using polyamide 56 and low moisture absorption polyphthalamide. All the samples were prepared on a TSM D6/2 Brabender extruder having 42 mm parallel counter-rotating twin screws. Depending upon the blend, the temperature of the extruder varied from about 250° C. to about 305° C.

Once the materials were mixed together in the twin screw extruder as set forth above, the material was then injection molded using a trial mold with one cavity into sample plaques 60×60×1 mm using a 130 ton SE-D Molding Machine having a 28 mm screw diameter. The injection temperature was about 285° C. to 315° C. and the mold temperature was about 80° C.

Example 1 was a control sample. In this example, only the polyamide 56 resin was used and no other material was blended with the polyamide 56 resin. The polyamide 56 resin was BIONYLA C100-NC002 from Kingfa Sci.& Tech. Co., Ltd.

Example 2 was a sample containing polyamide 56 resin and 5 wt. % of polyamide 10T blended together to form the polyamide 56 blended composition. The polyamide 56 resin used in this sample was BIONYLA C100-NC002 from Kingfa Sci.& Tech. Co., Ltd. The polyamide 10T used in this sample was VICNYL R6100 from Kingfa Sci.& Tech. Co., Ltd.

Example 3 was a sample containing polyamide 56 resin and 10 wt. % of polyamide 10T blended together to form the polyamide 56 blended composition. The polyamide 56 resin used in this sample was BIONYLA C100-NC002 from Kingfa Sci.& Tech. Co., Ltd. The polyamide 10T used in this sample was VICNYL R6100 from Kingfa Sci.& Tech. Co., Ltd.

Example 4 was a sample containing polyamide 56 resin and 5 wt. % of polyamide 10TX blended together to form the polyamide 56 blended composition. The polyamide 56 resin used in this sample was BIONYLA C100-NC002 from Kingfa Sci.& Tech. Co., Ltd. The polyamide 10TX used in this sample was VICYNL 2700 EB from Kingfa Sci.& Tech. Co., Ltd.

Example 5 was a sample containing polyamide 56 resin and 10 wt. % of polyamide 10TX blended together to form the polyamide 56 blended composition. The polyamide 56 resin used in this sample was BIONYLA C100-NC002 from Kingfa Sci.& Tech. Co., Ltd. The polyamide 10TX used in this sample was VICYNL 2700 EB from Kingfa Sci.& Tech. Co., Ltd.

The samples in Examples 1 through 5 were then subjected to water absorption testing in compliance with ASTM D570 (Oct. 12, 2022) and ISO 62:2008. The samples were dried at 210° F. (98.9° C.) for 8 hours. The dried samples of various compositions measuring 60×60×1 mm were immersed in water at room temperature of approximately 25° C. The water absorption percentage was measured as a function of time. Both the saturated water absorption percentage of each example as well as the water absorption reduction percentage compared to the control in Example 1 were then calculated.

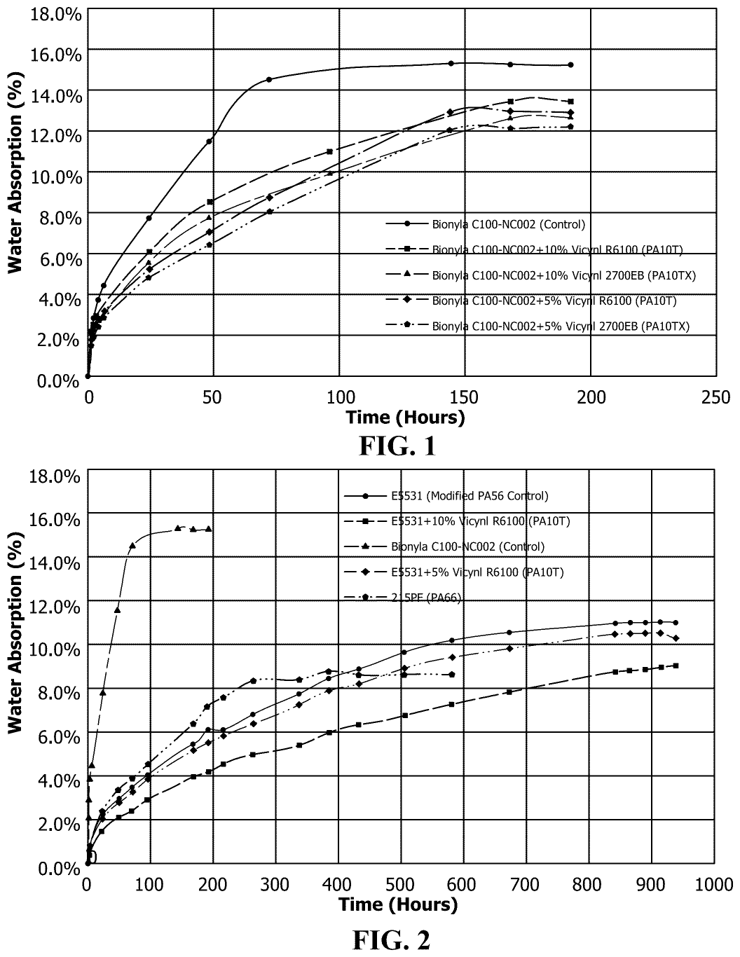

FIG. 1 is a graph showing the water absorption percentage as a function of time for each of the examples tested. The data shows that when using the low moisture absorption polyphthalamide in the desired amounts, the water absorption of the polyamide 56 blend composition is lower than the water absorption of polyamide 56 by itself. This FIG. 1 illustrates that the polyamide 56 blend composition has reduced moisture absorption compared to polyamide 56 by itself.

The table below shows the saturated water absorption percentages and the water absorption reduction percentages compared to the control, Example 1.

| | Saturated | Water |
|---|---|---|
| | water | absorption |
| | absorption | reduction |
| Example | percentage | percentage |
| 1 | 15.17 | 0 |
| 2 | 12.85 | 15.49 |
| 3 | 12.15 | 20.03 |
| 4 | 13.39 | 11.90 |
| 5 | 12.62 | 16.98 |

The data in the chart shows that using the low moisture absorption polyphthalamide in the desired amounts in a polyamide 56 blended composition results in reduced water absorption compared to polyamide 56 resin by itself.

In the next series of Examples, polyamide 66 resins, polyamide 56 resins, polyamide 56 copolymer resins and various blends of polyamide 56 copolymer with low moisture absorption polyphthalamide were used.

Example 6 was a polyamide 56 by itself. The polyamide 56 resin was BIONYLA C100-NC002 from Kingfa Sci.& Tech. Co., Ltd. Example 7 was a polyamide 56 resin copolymer by itself. The polyamide resin copolymer was ECOPENT 6631 from Cathay Biotech, Inc. Example 8 was a polyamide 66 by itself. The polyamide 66 resin was VYDYNE 21SPF from Ascend Performance Materials.

Example 9 was a polyamide 56 blended composition comprising a polyamide 56 copolymer and 5 wt. % of polyamide 10T. The polyamide 56 copolymer resin was ECOPENT 6631 from Cathay Biotech, Inc. The polyamide 10T used in Example 9 was VICNYL R6100 from Kingfa Sci.& Tech. Co., Ltd. Example 10 was a polyamide 56 blended composition comprising a polyamide 56 copolymer and 10 wt. % of polyamide 10T. The polyamide 56 copolymer resin was ECOPENT 6631 from Cathay Biotech, Inc. The polyamide 10T used in Example 12 was VICNYL R6100 from Kingfa Sci.& Tech. Co., Ltd.

Examples 6 through 10 were also subject to moisture testing in compliance with ASTM D570 (Oct. 12, 2022) and ISO 62:2008. Samples were dried at 210° F. (98.9° C.) for 8 hours. The dried samples measuring 60×60×1 mm were immersed in water at room temperature of approximately 25° C. The water absorption percentage was measured as a function of time. Both the saturated water absorption percentage of each example and the water absorption reduction percentage were calculated.

FIG. 2 is a graph showing the water absorption percentage as a function of time for each of the Examples 6-10 that were tested. The data show that the polyamide 56 blend composition comprising polyamide 56 copolymer with the polyamide 10T had similar saturated water absorption percentage as the conventional polyamide 66. In addition, the data show that the polyamide copolymer had a lower saturated water absorption percentage compared to polyamide 56 resin by itself.

The table below shows the saturated water absorption percentages and the water absorption reduction percentages of the polyamide 56 blended compositions compared to the control, Example 6.

| | Saturated water | Water absorption |
|---|---|---|
| | absorption | reduction |
| Example | percentage | percentage |
| 6 | 10.91 | 0 |
| 9 | 10.22 | 6.25 |
| 10 | 8.98 | 17.67 |

These data show that polyamide 56 blends comprising polyamide 56 copolymer with polyamide 10T have improved water absorption reduction percentages over polyamide 56 copolymer by itself.

All these examples show that the water absorption reduction percentages are significantly higher than the concentration of the low moisture absorption polyphthalamides in the polyamide 56 blended composition. Not wishing to be bound by this, it is believed that this unexpected result is due to morphology changes in the materials when blended together.

One skilled in the art will appreciate that the invention may be used with many modifications of structure, arrangement, proportions, sizes, materials and components and otherwise used in the practice of the invention, which are particularly adapted to specific environments and operative requirements without departing from the principles of the present invention. The presently disclosed embodiments are therefore to be considered in all respects as illustrative and not restrictive, the scope of the invention being defined by the appended claims, and not limited to the foregoing description or embodiments.

1. A polyamide 56 blended composition comprising a polyamide 56 polymer and low moisture absorption polyphthalamide.

2. The composition of claim 1, wherein said low moisture absorption polyphthalamide is a poly-condensation product of monomers comprising at least aliphatic diamine and at least one aromatic dicarboxylic acid.

3. The composition of claim 1, wherein said low moisture absorption polyphthalamide is poly(decamethylene terephthalamide) or its copolymer.

4. The composition of claim 1, wherein said low moisture absorption polyphthalamide comprises less than 20 wt. % of the polyamide 56 blended composition.

5. The composition of claim 1, wherein said low moisture absorption polyphthalamide comprises about 3 to about 10 wt. % of the polyamide 56 blended composition.

6. The composition of claim 1, wherein said low moisture absorption polyphthalamide comprises about 5 to about 10 wt. % of the polyamide 56 blended composition.

7. An article made of a polyamide 56 blended composition comprising a polyamide 56 or polyamide 56 copolymer and a low moisture absorption polyphthalamide.

8. The article of claim 7 wherein said low moisture absorption polyphthalamide is a poly-condensation product of monomers comprised of at least aliphatic diamine and at least one aromatic dicarboxylic acid.

9. The article of claim 7, wherein said low moisture absorption polyphthalamide is poly(decamethylene terephthalamide) or its copolymer.

10. The article of claim 7, wherein said low moisture absorption polyphthalamide comprises about 3 to about 10 wt. % of the polyamide 56 blended composition.

11. The article of claim 7, wherein said low moisture absorption polyphthalamide comprises about 5 to about 10 wt. % of the polyamide 56 blended composition.

12. A polyamide 56 blended composition comprising a polyamide 56 copolymer and low moisture absorption polyphthalamide.

13. The composition of claim 12, wherein said low moisture absorption polyphthalamide is a poly-condensation product of monomers comprised of at least aliphatic diamine and at least one aromatic dicarboxylic acid.

14. The composition of claim 12, wherein said low moisture absorption polyphthalamide comprises less than 20 wt. % of the polyamide 56 blended composition.

15. The composition of claim 12, wherein said low moisture absorption polyphthalamide comprises about 3 to about 10 wt. % of the polyamide 56 blended composition.

16. The composition of claim 12, wherein said low moisture absorption polyphthalamide comprises about 5 to about 10 wt. % of the polyamide 56 blended composition.

17. The composition of claim 12, wherein said low moisture absorption polyphthalamide is poly(decamethylene terephthalamide) or its copolymer.

18. The composition of claim 12, wherein said low moisture absorption polyphthalamide is poly(decamethylene terephthalamide) or its copolymer.

19. The composition of claim 12, wherein said composition is formed into an article.

20. The composition of claim 13, wherein said composition is formed into an article.
